(19) United States
(12) Patent Application Publication
(10) Pub. No.: US 2011/0123834 A1
(43) Pub. Date: May 26, 2011

(54) MAGNETIC RECORDING MEDIUM GLASS SUBSTRATE AND METHOD OF MANUFACTURING THE SAME

(75) Inventors: Tomohiro Hoshino, Tokyo (JP); Izuru Kashima, Tokyo (JP); Ryu Yamaguchi, Tokyo (JP); Tatsuya Yamasaki, Tokyo (JP)

(73) Assignee: Asahi Glass Company, Limited, Chiyoda-ku (JP)

(21) Appl. No.: 12/953,910

(22) Filed: Nov. 24, 2010

(30) Foreign Application Priority Data
Nov. 26, 2009 (JP) 2009-268998

(51) Int. Cl. G11B 5/82; B24B 1/00; G11B 5/62

(52) U.S. Cl. 428/846.9; 451/41

(57) ABSTRACT

An abrasion brush in which a width of each of bristle implanting portions is 1.1 to 2.2 times a stack width of stacked glass substrates (a thickness of each of the glass substrates when the glass substrates are stacked without using a spacer. or a sum of the thickness of the glass substrates and a spacer when the glass substrates are stacked using spacers) is used for an inner periphery end surface polishing of a magnetic recording medium glass substrate. By performing the inner periphery end surface polishing using the abrasion brush, scratches remaining in a chamfering portion of the glass substrate can be removed reliably with a high productivity, and it is possible to provide the magnetic recording medium glass substrate without pit defects in the chamfering portion.

### TECHNICAL FIELD

The present disclosure relates to a method of manufacturing a magnetic recording medium glass substrate by polishing side surface portions and chamfering portions of a plurality of stacked glass substrates.

### RELATED ART

Along with a high recording density demanded of a magnetic disk in recent years, properties demanded of the magnetic recording medium glass substrate become stricter every year. Particularly, in order to achieve a high recording density, it is important to reduce foreign material defects in a main surface of a glass substrate in order to improve the smoothness and enhance the mechanical strength of the glass substrate and to improve the reliability as an information recording medium.

In a manufacturing process of a glass substrate for a disk-shaped magnetic recording medium having a circular hole at a center portion thereof, the end surface polishing of the glass substrate is performed to remove scratches and concavities and convexities in the side surface portion or the chamfering portion of the glass substrate to finish a smooth mirror surface. Finishing the side surface portion or the chamfering portion of the glass substrate as a smooth mirror surface has the effects of improving the mechanical strength of the glass substrate, reducing the quantity of foreign material caught in concavities and convexities of the side surface portion or the end surface portion, and reducing particles generated by the cutting of a resin member of the cassette due to concavities and convexities of the side surface portion or the end surface portion or the like.

For example, in an inner periphery end surface polishing of the glass substrate for the magnetic recording medium, after forming a chamfering portion at an inner periphery side surface portion of the glass substrate, a plurality of glass substrates is stacked, a polishing liquid containing a free abrasive grain is supplied to the inner periphery side surface portion of the glass substrate, and an abrasion brush implanted with brush bristles on a rotation shaft is brought into contact with the inner periphery side surface and the inner periphery chamfering surface portion in the state of rotating, thereby performing the polishing.

However, when each of a plurality of side surface portions and chamfering portions of the glass substrate are concurrently polished in a state in which a plurality of glass substrates is stacked, there is a problem in that the polishing amount of the chamfering portion becomes smaller than the polishing amount of the side surface portion, and scratches and concavities and convexities in the chamfering portion cannot be sufficiently removed, which makes it impossible to finish the smooth mirror surface.

In order to reliably polish the side surface portion and the chamfering portion of the glass substrate with high productivity, there are several proposed methods of using a curled fiber in the brush bristles of the abrasion brush (Patent Document 1), and using a bristle end-shaped thin fiber in the brush bristles of the abrasion brush (Patent Documents 2 and 3). However, such methods are not necessarily sufficient from the viewpoint of removing scratches or concavities and convexities in the chamfering portion of the glass substrate to reliably finish the smooth mirror surface. In order to reliably polish the side surface portion and the chamfering portion of the glass substrate, methods of separately and dividedly performing the polishing of the side surface portion and the chamfering portion are proposed (Patent Documents 4 and 5); however, such methods have poor efficiency and are not necessarily sufficient from the viewpoint of productivity.

### RELATED ART DOCUMENT

### Patent Document

[Patent Document 1] JP 4156504
[Patent Document 2] JP-A-2007-118173
[Patent Document 3] JP-A-2007-245319
[Patent Document 4] JP-A-2007-197235
[Patent Document 5] JP-A-2008-84521

### SUMMARY

Exemplary embodiments of the present invention provide a glass substrate without pit defects in a chamfering portion of the glass substrate. Furthermore, exemplary embodiments of the present invention provide an end surface polishing method of a glass substrate that reliably polishes a side surface portion and a chamfering portion of a glass substrate with a high productivity, and a method of manufacturing a glass substrate for a magnetic recording medium.

A magnetic recording medium glass substrate, according to an exemplary embodiment of the present invention, is manufactured by a method of manufacturing a magnetic recording medium glass substrate comprising:

preparing a plurality of glass substrates, each of which has a disk shape including a circular hole in a center portion of the glass substrate, an inner periphery side surface, an outer periphery side surface, and upper and lower main surfaces;

polishing the main surfaces of each of the glass substrates;

performing chamfering machining of the inner periphery side surface of each of the glass substrates to form an inner periphery chamfering portion; and

polishing the inner periphery side surface and the inner periphery chamfering portion of each of the glass substrates by:
stacking the plurality of glass substrates,
supplying a polishing liquid containing free abrasive grains to the inner periphery side surfaces and the inner periphery chamfering portions of the glass substrates, and
bringing an abrasion brush, which has a rotation shaft and brush bristles implanted in the rotation shaft, into contact with the inner periphery side surfaces and the inner periphery chamfering portions while rotating the abrasion brush,

wherein the abrasion brush has bristle implanting portions where the brush bristles are implanted and non-bristle implanting portions where the brush bristles are not implanted, and

wherein the bristle implanting portions are formed to have a pitch width so that the non-bristle implanting portions are formed between the bristle implanting portions, and

wherein a width of each of the bristle implanting portions is 1.1 to 2.2 times a stack width of the stacked glass substrates, and

in at least one of the inner periphery chamfering portion and the outer periphery chamfering portion of the magnetic recording medium glass substrate, the number of pit defects, which have a diameter of 10 μm or more, is equal to or less than 5/mm².

A method of manufacturing a magnetic recording medium glass substrate of the present embodiment may reliably and concurrently polish the side surface portion and the chamfering portion of the glass substrate with a high productivity, by suitably selecting the design of the abrasion brush of the end surface polishing and the end surface polishing condition. As a result, it may be possible to provide a magnetic recording medium glass substrate without pit defects in a chamfering portion of the glass substrate with high productivity. Thus, it is possible to reduce problems such as a decline in mechanical strength of the glass substrate caused by scratches remaining in the side surface portion and the chamfering portion of the glass substrate, an increase in foreign material defects of a main surface of the glass substrate caused by foreign material caught in concavities and convexities of the side surface portion and the chamfering portion or the like.

### BRIEF DESCRIPTION OF THE DRAWINGS

FIG. 1 is a schematic cross-sectional view of an abrasion brush;

FIG. 2 is an enlarged cross-sectional view showing a configuration of the abrasion brush;

FIG. 3 is a schematic diagram showing a configuration in which a glass substrate stacked body with stacked magnetic recording medium glass substrates is subjected to an inner periphery surface polishing using an abrasion brush;

FIG. 4 is a cross-sectional perspective view of the glass substrate for the magnetic recording medium;

FIG. 5 is a microscopic observation image of the inner periphery surface chamfering portion (good product) without pit defects; and

FIG. 6 is a microscopic observation image of the inner periphery surface chamfering portion (faulty product) with pit defects.

### DETAILED DESCRIPTION

Hereinafter, exemplary embodiments will be described, but the present invention is not limited to the embodiments described below.

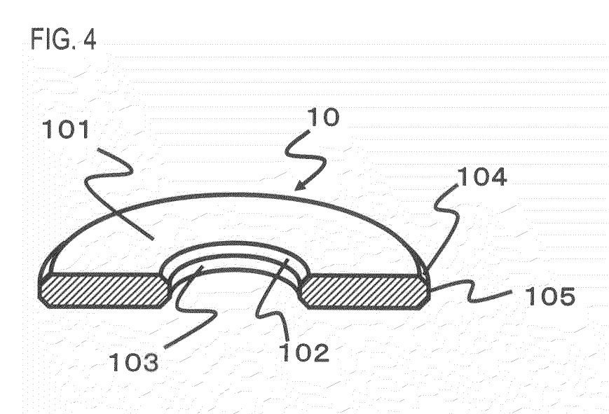

Firstly, a cross-sectional perspective view of a magnetic recording medium glass substrate 10 of the present invention is shown in FIG. 4. In FIG. 4, a main surface 101 of the magnetic recording medium glass substrate, an inner periphery surface chamfering portion 102, an inner periphery side surface portion 103, an outer periphery chamfering portion 104, and an outer periphery side surface portion 105 are shown respectively.

In general, a production process of the magnetic recording medium glass substrate and the magnetic disk includes the following processes. (1) After a glass material substrate formed by a float method, a press molding method or a fusion method is machined in a disk shape, the inner periphery side surface and the outer periphery side surface are subject to chamfering machining. (2) Upper and lower main surfaces of the glass substrate are subjected to a wrapping machining. (3) The side surface portion and the chamfering portion of the glass substrate are subjected to an end surface polishing. (4) The upper and lower main surfaces of the glass substrate are polished. The polishing process may be simply a primary polishing or a primary polishing and a secondary polishing may both be performed, or a tertiary polishing may be performed after the secondary polishing. (5) A precision cleaning of the glass substrate is performed to produce the magnetic recording medium glass substrate. (6) A thin film such as a magnetic layer is formed on the magnetic recording medium glass substrate to produce a magnetic disk.

Furthermore, in the production process of the magnetic recording medium glass substrate and the magnetic disk, the glass substrate cleaning (inter-process cleaning) or the etching (inter-process etching) of the glass substrate surface may be performed between each process. In addition, in a case where a high mechanical strength is required for the magnetic recording medium glass substrate, a reinforcement process (for example, a chemical reinforcement process) of forming a reinforcement layer on a surface layer of the glass substrate may be performed before the polishing process or after the polishing process, or between the polishing processes.

In the present invention, the magnetic recording medium glass substrate may be an amorphous glass, a crystallization glass, and a reinforcement glass (e.g., a chemical reinforcement glass) having a reinforcement layer on the surface layer of the glass substrate. Furthermore, the glass material substrate of the glass substrate of the present invention may be produced by a float method, a press molding method, or a fusion method.

The present invention relates to (3) a process of performing the end surface polishing on the side surface portion and the chamfering portion of the glass substrate, and also relates to the inner periphery end surface polishing of the magnetic recording medium glass substrate.

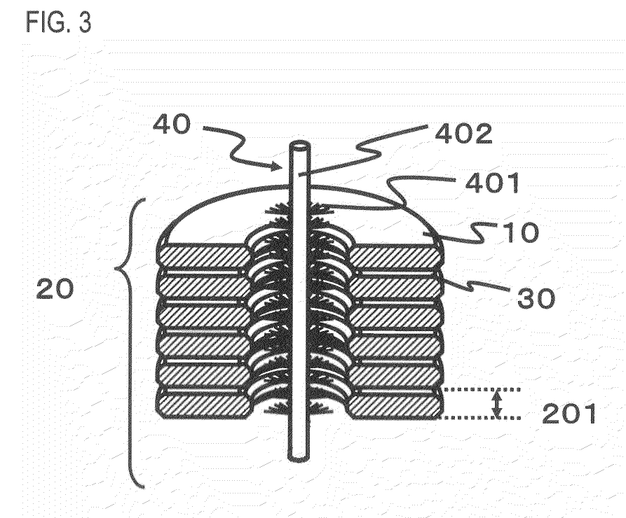

FIG. 3 shows a schematic diagram that indicates the configuration of the inner periphery end surface polishing of the magnetic recording medium glass substrate. A plurality of stacked glass substrates (hereinafter, referred to as glass substrate stacked body) 20 is installed on a holding portion that holds the glass substrate stacked body of an inner periphery end surface polishing apparatus, an abrasion brush 40 is inserted into a circular hole formed in a center portion of the glass substrate to bring brush bristles 401 into contact with an inner periphery side surface portion 103 and the inner periphery chamfering portion 102 of the glass substrate, a polishing liquid containing the free abrasive grain is supplied to the inner periphery side surface portion 103 and the inner periphery chamfering portion 102 of the glass substrate, and the glass substrate stacked body 20 and the abrasion brush 40 are rotated in opposite directions, thereby concurrently polishing the inner periphery side surface portion 103 and the inner periphery chamfering portion 102 of the glass substrate.

The glass substrate stacked body 20 may be formed by stacking only the magnetic recording medium glass substrates 10, or may be formed by alternately stacking the magnetic recording medium glass substrates 10 and spacers 30. When the magnetic recording medium glass substrates 10 and the spacers 30 are alternately stacked, the spacers 30 suppress the occurrence of scratches on the main surface 101 of the glass substrate, so that the brush bristles 401 or the polishing liquid reliably reach the inner part of the inner periphery chamfering portion 102 of the stacked glass substrate. Thus, a magnetic recording medium glass substrate 10 of a high quality is easily obtained.

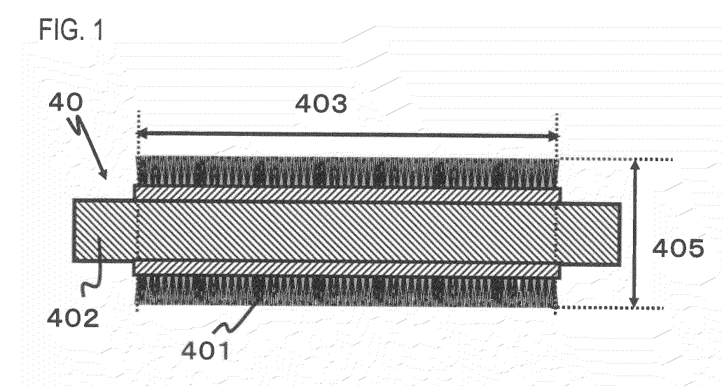

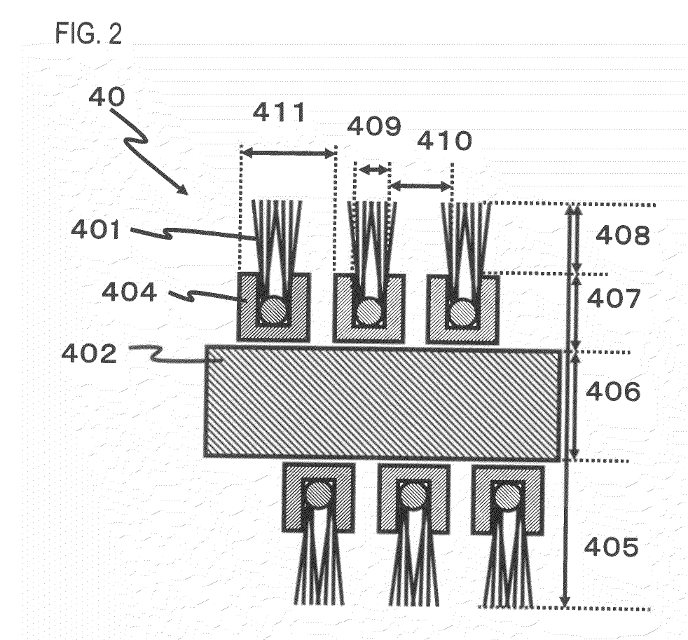

A schematic cross-sectional diagram of the abrasion brush 40 is shown in FIG. 1 and an enlarged cross-sectional view thereof is shown in FIG. 2, respectively. The abrasion brush 40 is configured so that the brush bristles 401 are implanted in a direction perpendicular to a rotation shaft 402. It is desirable that a bristle implanting length 403 (a length of a bristle implanting portion in which the brush bristles are implanted on the abrasion brush) of the brush bristles 401 on the rotation shaft 402 is longer than the whole length of the glass substrate stacked body 20 in order to allow the inner periphery end surface polishing to be performed uniformly.

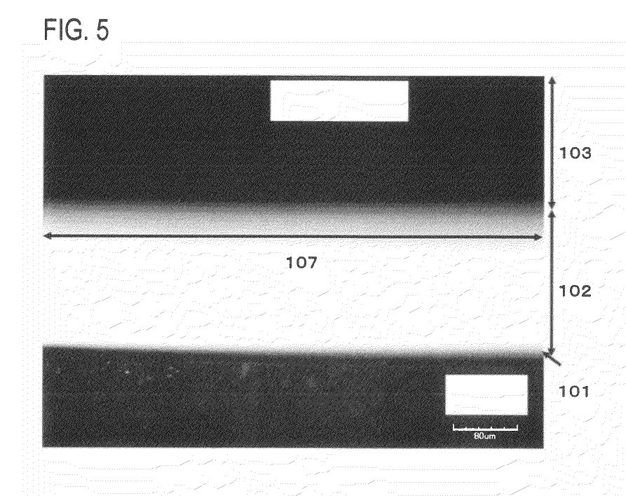

A method of implanting the brush bristles 401 on the rotation shaft of the abrasion brush 40 is not particularly limited, but, as shown in FIG. 5, a method in which channel components 404 implanted with the brush bristles 401 are wound around and fixed to the rotation shaft 402, and a method of directly implanting the brush bristles 401 in concave-shaped grooves formed in the rotation shaft 402 or the like may be considered. Since the abrasion brush 40 in which the channel components 404 implanted with the brush bristles 401 are wound around and fixed to the rotation shaft 402 has a high degree of freedom in terms of the abrasion brush design for performing a desired inner periphery end surface polishing, the abrasion brush 40 is desirable as the abrasion brush of the inner periphery end surface polishing.

The abrasion brush 40 in which the channel component 404 implanted with the brush bristles 401 is wound around and fixed to the rotation shaft 402 regulates a width 409 of the bristle implanting portion and a width 410 of a non-bristle implanting portion on the abrasion brush by changing the width 409 of the bristle implanting portion of the channel component 404 and a pitch width 411 by which the channel component 404 is wound around the rotation shaft, which makes it possible to set a local density of the brush bristles to a desired range.

When the local density of the brush bristles is low, the polishing velocity decreases. On the other hand, when the local density of the brush bristles is high, the brush bristles react with each other, and it is difficult to reliably make the brush bristles reach up to the inner part of the inner periphery chamfering portion of the glass substrate, whereby the number of the pit defects in the chamfering portion increases. Furthermore, since it is impossible to suitably perform the supply of the polishing liquid to the inner periphery side surface portion and the inner periphery chamfering portion of the glass substrate, there is a problem in that the polishing velocity fluctuates, whereby a variation occurs in the polishing amount within the glass substrate stacked body.

The width 409 of the bristle implanting portion of the channel component 404 is 1.1 to 2.2 times a stack width 201 (a thickness of the combination of the glass substrate and the spacer, or, a thickness of the glass substrate in the case of the glass substrate stacked body without the spacer) of the glass substrates of the glass substrate stacked body 20. In a case where the width 409 of the bristle implanting portion is less than 1.1 times the stack width 201 of the glass substrates of the glass substrate stacked body 20, the polishing velocity may decrease. In a case where the width 409 of the bristle implanting portion exceeds 2.2 times the stack width 201 of the glass substrates of the glass substrate stacked body 20, the brush bristles react with each other and it is difficult to reliably make the brush bristles reach up to the inner part of the inner periphery chamfering portion of the glass substrate, whereby the polishing of the chamfering portion cannot be sufficiently performed, and the number of pit defects in the chamfering portion may increase.

The width 409 of the bristle implanting portion is 1.1 to 2.2 times the stack width 201 of the glass substrates of the glass substrate stacked body 20, preferably 1.1 to 2.0 times, and, particularly preferably, 1.2 to 2.0 times.

The width 410 of the non-bristle implanting portion on the abrasion brush is adjusted by the pitch width 411, which controls how the channel component is wound around the rotation shaft. Preferably, the width 410 of the non-bristle implanting portion is 3 to 9 mm. In a case where the width 410 of the non-bristle implanting portion on the abrasion brush is less than 3 mm, since the polishing liquid cannot be suitably supplied to the inner periphery side surface portion and the inner periphery chamfering portion of the glass substrate, a variation may occur in the polishing amount in the glass substrate stacked body. In a case where the width 410 of the non-bristle implanting portion on the abrasion brush exceeds 9 mm, the polishing velocity may decrease and the life expectancy of the brush bristles may decline.

The width 410 of the non-bristle implanting portion on the abrasion brush may be 3 to 9 mm, preferably 4 to 8 mm, and, particularly preferably, 5 to 8 mm.

An outer diameter 405 of the abrasion brush may be larger than the diameter of the circular hole of the glass substrate that is subjected to the inner periphery end surface polishing. In a case where the outer diameter 405 of the abrasion brush is smaller than the diameter of the circular hole of the glass substrate that is subjected to the inner periphery end surface polishing, the abrasion brush 40 is moved until it is brought into contact with the inner periphery side surface portion 103 and the inner periphery chamfering portion 102 of the glass substrate, and then the inner periphery surface polishing is performed. When the abrasion brush 40 is moved so as to be brought into contact with the inner periphery side surface portion and the inner periphery chamfering portion of the glass substrate stacked body 20, there is a problem in that the abrasion brush 40 is bent, the brush bristles 401 of the abrasion brush cannot be uniformly brought into contact with the whole area of the glass substrates of the glass substrate stacked body 20, and the polishing amount varies depending on the positions of the glass substrate stacked body 20, whereby a variation of the end surface polishing may occur within the glass substrate stacked body (within the same lot).

In order to suppress the bending of the abrasion brush generated by large movement before the abrasion brush 40 is brought into contact with the inner periphery side surface portion 103 and the inner periphery chamfering portion 102 of the glass substrate, to thereby perform uniform end surface polishing of the whole area of the glass substrates of the glass substrate stacked body, the outer diameter 405 of the abrasion brush may be larger than the diameter of the circular hole of the glass substrate. It is desirable that the outer diameter 405 of the abrasion brush is 1.03 to 1.25 times the diameter of the circular hole of the glass substrate.

In a case where the outer diameter of the abrasion brush is less than 1.03 times the diameter of the circular hole of the glass substrate, since the abrasion brush 40 undergoes large movement until the brush bristles 401 come into contact with the inner periphery side surface portion and the inner periphery chamfering portion of the glass substrate, the abrasion brush is greatly bent, the brush bristles 401 of the abrasion brush cannot be uniformly brought into contact with the whole of the glass substrates of the glass substrate stacked body 20, and the polishing amount varies depending on the position of the glass substrate stacked body, whereby it is impossible to uniformly polish the end surface portions of the glass substrates of the glass substrate stacked body 20. In addition, since it is impossible to polish the end surfaces in entire periphery of the abrasion brush 40, the polishing velocity may decrease and the productivity may be deteriorated.

In a case where the outer diameter 405 of the abrasion brush exceeds 1.25 times the diameter of the circular hole of the glass substrate, there is a problem in that an overlap between the brush bristles 401 and the inner periphery side surface portion and the inner periphery chamfering portion of the glass substrate becomes larger, the life expectancy of the brush bristles are reduced, the front ends of the brush bristles are bent, and the front ends of the brush bristles cannot be brought into contact with the inner periphery side surface portion and the inner periphery chamfering portion of the glass substrate uniformly with a suitable pressure, whereby it is impossible to uniformly perform the end surface polishing.

The outer diameter 405 of the abrasion brush may be 1.03 to 1.25 times the diameter of the circular hole of the glass substrate, preferably 1.03 to 1.20 times, and, particularly preferably, 1.05 to 1.15 times.

The outer diameter 405 of the abrasion brush can be adjusted by a diameter 406 of the rotation shaft of the abrasion brush, or a height 407 of the channel component implanted with the brush bristles 401, and lengths 408 of the brush bristles.

The diameter 406 of the rotation shaft of the abrasion brush may be 41% to 65% of the diameter of the circular hole of the glass substrate. In a case where the diameter 406 of the rotation shaft of the abrasion brush is less than 41% of the diameter of the circular hole of the glass substrate, since the lengths 408 of the brush bristles are lengthened, it is impossible to bring the brush bristles into contact with the inner periphery side surface portion and the inner periphery chamfering portion of the glass substrate by a suitable pressure, whereby the polishing velocity may decrease.

On the other hand, in a case where the diameter 406 of the rotation shaft of the abrasion brush exceeds 65% of the diameter of the circular hole of the glass substrate, since it is impossible to suitably provide the polishing liquid to the inner periphery side surface portion and the inner periphery chamfering portion of the glass substrate, the polishing velocity may decrease, and a variation may occur in the polishing amount within the glass substrate stacked body. Moreover, since the lengths of the brush bristles are shortened, it is difficult to reliably make the brush bristles reach up to the inner part of the inner periphery chamfering portion of the glass substrate, the polishing of the chamfering portion cannot be sufficiently performed, and the number of pit defects in the chamfering portion may increase.

The diameter 406 of the rotation shaft of the abrasion brush may be 41% to 65% of the diameter of the circular hole of the glass substrate, preferably 43% to 60%, and particularly preferably, 45% to 55%.

The height 407 of the channel component implanted with the brush bristles 401 is preferably 0.5 mm to 3.0 mm, and more preferably, 1.5 mm to 2.7 mm. When the height of the channel component is less than 0.3 mm, the brush bristles are spread at the time of the polishing machining, the brush bristles cannot be brought into contact with the inner periphery side surface portion and the inner periphery chamfering portion of the glass substrate by a suitable pressure, whereby the polishing velocity may decrease.

In a case where the height of the channel component exceeds 3.0 mm, since the brush bristles are shortened, it is difficult to reliably make the brush bristles reach up to the inner part of the inner periphery chamfering portion of the glass substrate, the chamfering portion cannot be sufficiently polished, and the number of pit defects in the chamfering portion may increase.

The bristle diameter of the brush bristles 401 is preferably 0.10 mm to 0.20 mm. When the bristle diameter of the brush bristles is less than 0.10 mm, aging of the brush bristles may increase. When the bristle diameter of the brush bristles 401 exceeds 0.20 mm, the brush bristles cannot reliably reach up to the inner part of the inner periphery chamfering portion of the glass substrate, the chamfering portion cannot be sufficiently polished, and the number of pit defects in the chamfering portion may increase. The bristle diameter of the brush bristles is preferably 0.10 mm to 0.20 mm, and more preferably, 0.12 mm to 0.18 mm.

The brush bristles can be arbitrarily selected from among a chemical synthetic fiber such as nylon fiber or polypropylene fiber, vinyl chloride fiber, polybutylene terephthalate fiber, hairs of animals such as pigs or horses, a metal wire such as a piano wire or stainless fiber depending on the usage purpose.

In the inner periphery end surface polishing of the magnetic recording medium glass substrate 10, it is desirable to perform the end surface polishing while swinging the abrasion brush 40 in a stack direction of the glass substrate stacked body 20 in order to further enhance the uniformity of the polishing amount in the glass substrate stacked body. The swing length of the abrasion brush 40 is preferably equal to or larger than 15% of the overall length T of the glass substrate stacked body. In a case where the swing length of the abrasion brush is less than 15% of the whole length T of the glass substrate stacked body 20, a variation of the polishing amount in the glass substrate stacked body caused by the variation of the characteristics of the abrasion brush may occur.

In the production process of the magnetic recording medium glass substrate, the end surface polishing is performed to remove a machining damage layer such as scratches on the side surface portion or the chamfering portion and smooth concavities and convexities to form a mirror surface.

The chamfering machining of the inner periphery side surface portion is generally performed using a grinding stone to which diamond abrasive grains are fixed, but at that time, the machining damage layer (scratches etc.) is generated in the inner periphery side surface portion 103 and the inner periphery chamfering portion 102. The machining damage layer generated by the chamfering machining is removed by the end surface polishing. However, if the polishing amount is insufficient, the machining damage layer is not completely removed but remains in the inner periphery side surface portion 103 or the inner periphery chamfering portion 102. The machining damage layer remaining in the side surface portion and the chamfering portion of the glass substrate becomes a cause of problems such as decline in mechanical strength of the glass substrate or an increase in foreign material defects of the main surface of the glass substrate, and generates a disadvantage upon producing a magnetic disk. Thus, it is necessary to reliably perform the polishing of both of the side surface portion and the chamfering portion, thereby reliably removing the machining damage layer.

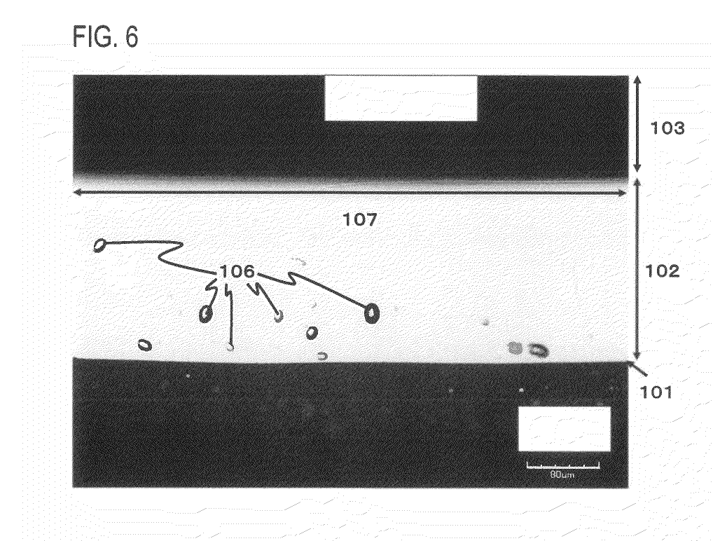

Generally, in the end surface polishing of the glass substrate stacked body using the abrasion brush, since the polishing amount of the chamfering portion is smaller than that of the side surface portion, the machining damage layer readily remains in the chamfering portion more than the side surface portion. The machining damage layer remaining in the surface of the glass substrate is subject to isotropic etching with the scratch as a center by etching the surface of the glass substrate and the scratch becomes a circular-shaped or an oval-shaped pit defect, so that it can be conveniently evaluated using an optical microscope or the like. A microscopic observation image of the inner periphery chamfering portion (a good product) of the magnetic recording medium glass substrate 10 without the pit defect is shown in FIG. 5. A microscopic observation image of the inner periphery chamfering portion (a faulty product) with the pit defect is shown in FIG. 6. In FIG. 6, reference numerals 106 refer to the pit defects.

The number of pit defects in the chamfering portion of the magnetic recording medium glass substrate 10 is evaluated by the following sequence. The surface of the glass substrate is etched to 5 μm using an acidic etching solution containing hydrofluoric acid, acetic acid or the like, the machining damage layer (the scratches etc.) remaining in the chamfering portion is isotropically etched to make the pit defects 106 have sizes that are easy to observe, and then the pit defects 106 are observed using an optical microscope. The chamfering portion of the magnetic recording medium glass substrate 10 is observed by the optical microscope, concave portions having a circular shape or an oval shape having a diameter (or the long diameter) of 10 μm or more are defined as the pit defects 106, and the numbers thereof are determined. Evaluation of the pit defects 106 may be performed for the overall region of the chamfering portion formed at both main surface sides of the glass substrate, and may be performed at a selected specific place. In the present embodiment, the number of pit defects was evaluated in the chamfering portion formed at both main surface sides of the glass substrate, at positions of gaps of 0°, 90°, 180°, and 270°, i.e., at a total of 8 positions.

In the present invention, the number of pit defects in the chamfering portion of the magnetic recording medium glass substrate is equal to or less than 5/mm². If the number of pit defects in the chamfering portion of the magnetic recording medium glass substrate is large, there is a problem in that the mechanical strength of the glass substrate declines or the foreign material caught in the concave portion of the chamfering portion becomes a cause of an increase in foreign material defects of the main surface of the glass substrate. The number of pit defects in the chamfering portion may be equal to or less than 3/mm², preferably equal to or less than 1/mm², particularly preferably 0/mm².

In addition, in a region of the whole periphery of the chamfering portion of the magnetic recording medium glass substrate, in a case of observing whether or not pit defects exist, a dark sight type optical microscope (produced by Vision Psytec Company, product name: Micro-Max VMI-2500F) may be used.

### EMBODIMENTS

Hereinafter, the present invention will be further described through an embodiment and a comparison example, but the present invention is not limited thereto.

A silicate glass plate formed by a float method is machined into a doughnut-shaped circular glass substrate (a disk-shaped glass plate having a circular hole at a center portion thereof) so as to obtain a magnetic recording medium glass substrate having an outer diameter of 65 mm, an inner diameter of 20 mm, and a plate thickness of 0.635 mm.

An inner periphery side surface and an outer periphery side surface of the doughnut-shaped circular glass plate were subjected to chamfering machining so as to obtain a magnetic recording medium glass substrate having a chamfering width of 0.15 mm and a chamfering angle of 45°, then the wrapping of upper and lower surfaces of the glass plate was performed using aluminum oxide abrasive grain, and the abrasive grain was cleaned off and removed.

Next, the inner periphery side surface portion and the inner periphery chamfering portion were polished using the abrasion brush and a cerium oxide abrasive grain to form a mirror surface. The inner periphery end surface polishing was performed using the following sequence by using an inner periphery end surface polishing apparatus (produced by UTK System Company, product name: BTK-08) and using a polishing liquid (a polishing liquid having cerium oxide of an average particle diameter (hereinafter, called an average particle size) of about 1.4 μm with an adjusted specific gravity of 1.2 as a main ingredient) containing cerium oxide abrasive grain and the abrasion brush as a polishing tool.

The doughnut-shaped circular glass plates were stacked using an alignment jig to form a glass substrate stacked body that is a polishing object.

The number of the glass substrates stacked on the glass substrate stacked body is set to 100 to 300 to match a production situation. In the present embodiment, the number of glass substrates in the stack was 200, resin spacers were inserted between the stacked glass substrates, and a glass substrate stacked body was formed so that the glass substrates and the resin spacers were alternately arranged. In the present embodiment, the plate thickness of the glass substrate was 0.67 mm and the thickness of the resin spacer was 0.2 mm.

Next, after the glass substrate stacked body was inserted into an inner periphery end surface polishing jig and fastened and fixed from the up and down direction of the glass substrate stacked body, the alignment jig was detached from the glass substrate stacked body. The glass substrate stacked body fixed to the inner periphery end surface polishing jig was installed on a polishing object holding portion of the inner periphery end surface polishing apparatus, and the abrasion brush was inserted into a circular hole of a center portion of the glass substrate stacked body. The abrasion brush was moved from the center of the circular hole of the glass substrate stacked body in a direction so that the brush bristles reliably came into contact with the inner periphery side surface portion and the inner periphery chamfering portion of the glass substrate stacked body, and the brush bristles were pressed with respect to the inner periphery side surface portion and the inner periphery chamfering portion of the glass substrate stacked body by a certain amount (a abrasion brush pressing amount). The inner periphery end surface polishing was performed in a state in which the abrasion brush was pressed with respect to the inner periphery side surface portion and the inner periphery chamfering portion of the glass substrate stacked body that is a polishing object by a certain amount.

After confirming that the brush bristles were in contact with the inner periphery end surface portion of the glass substrate stacked body, the polishing liquid containing the cerium oxide abrasive grain was supplied to the inner periphery end surface portion of the glass substrate stacked body, and the inner periphery side surface portion and the inner periphery chamfering portion were concurrently polished while rotating the abrasion brush and the glass substrate in opposite directions. In order to uniformly perform the end surface polishing all over the glass substrate stacked body, the abrasion brush performed the polishing while swinging in the stack direction of the glass substrate stacked body (the swing velocity was set to 100 to 1500 mm/min).

In the present embodiment, the polishing liquid was supplied at 7 to 8 L/min, the rotation velocity of the abrasion brush was 2500 rpm, and the rotation velocity of the glass substrate stacked body was 39 rpm. The polishing time was set so that the polishing amount of the inner periphery side surface portion became 12.5 μm. Furthermore, in order to carry out the end surface polishing in a stable state, it is suitable to perform a treatment (a dummy polishing using a dummy glass substrate) of warming air in the apparatus or familiarizing the abrasion brush with the polishing liquid before the end surface polishing.

After the inner periphery end surface polishing, the glass substrate stacked body is detached from the inner periphery end surface polishing jig, and the glass substrates are separated from the glass substrate stacked body one by one. The glass substrates separated one by one are subjected to the cleaning and removal of the abrasive grains by a scrub cleaning using an alkali detergent.

The measurement of the polishing amount of the inner periphery end surface polishing was measured using a highly accurate two-dimensional size measurer (produced by Keyence Corporation, production name: VM8040) after cleaning and drying the glass substrate. The polishing amount of the inner periphery end surface polishing was obtained by measuring the diameter of the circular hole of the glass substrate center portion at the inner periphery side surface portion before and after the inner periphery end surface polishing and calculating a difference in circular hole diameters before and after the end surface polishing. In order to measure the polishing amount, one sheet in every ten sheets of glass substrates was taken out of the glass substrate stacked body (200 sheets) at a time, in total 20 sheets of glass substrates were taken out. Then, a difference in circular hole diameters before and after the end surface polishing of each glass substrate was obtained, and the average value thereof was obtained as the polishing amount of the inner periphery end surface polishing.

(polishing amount of the inner periphery end surface polishing)=[(diameter of

the circular hole of the glass substrate after the polishing)−(diameter of the circular

hole of the glass substrate before the polishing)]/2

The evaluation of the number of pit defects in the chamfering portion was performed by etching the surface of the glass substrate by 5 μm using an acidic etching solution containing hydrofluoric acid, acetic acid or the like, isotropically etching the machining damage layer (a scratch or the like) remaining in the chamfering portion, and making the machining damage layer into a pit defect that was easy to observe. The etching amount of the glass substrate was measured by the same measurement method as the polishing amount of the inner periphery end surface polishing.

After performing the cleaning and the drying, the glass substrate in which the surface was etched by 5 μm was cut into a size in which it was easy to evaluate the number of pit defects in the chamfering portion (a pit defect number observation sample of 2 mm square including the inner periphery chamfering portion). The number of pit defects in the chamfering portion was evaluated using a laser microscope (produced by Olympus Corporation, product name: LEXT OLS 3500). The number of the pit defects in the inner periphery chamfering portion was evaluated by fixing the pit defect number observation sample to a sample table and installing the inner periphery chamfering portion so that the surface of the inner periphery chamfering portion was parallel to a lens surface of an object lens of the laser microscope. The object lens of the laser microscope was a twenty magnification, the observation sight was set to 635 μm×480 μm (an observation region where the inner periphery length 107 of the inner periphery chamfering portion becomes 635 μm), and the number of pit defects having a circular shape or an oval shape with a diameter (or a long diameter) of 10 μm or more was counted. The number of pit defects was evaluated at a total of 8 positions of 0°, 90°, 180°, and 270° in the chamfering portions formed at both main surface sides of the glass substrate. A glass substrate having a value, in which the number of pit defects measured in each evaluation place is divided by an observation region area, of 5/mm² or less was determined as a good product. The number of pit defects was evaluated by taking one sheet in every 10 sheets of glass substrates at a time, in total 20 sheets out of the glass substrate stacked body (200 sheets).

Next, the glass substrates, which had been subjected to the inner periphery end surface polishing, were machined so that the outer periphery side surface and the outer periphery chamfering portion were polished using the polishing liquid containing cerium oxide abrasive grain and the abrasion brush and the scratches on the outer periphery side surface and the outer periphery chamfering portion were removed to form a mirror surface. The polishing time of the outer periphery end surface polishing was adjusted so that the polishing amount of the outer periphery side surface portion became 12.5 μm. The glass substrates which had been subjected to the outer periphery end surface polishing were subjected to a scrub cleaning using alkali detergent to clean and remove the abrasive grain.

Thereafter, the polishing machining of the upper and lower main surfaces was performed by a double-sided polishing apparatus using the polishing liquid (a polishing liquid composite having cerium oxide with an average particle size of about 1.1 μm as a main ingredient) containing cerium oxide abrasive grain and a hard urethane pad as a polishing tool, and cerium oxide was cleaned off and removed.

In addition, the polishing machining of the upper and lower main surfaces was performed by a double-sided polishing apparatus using a polishing liquid (a polishing liquid composite having cerium oxide with an average particle size of about 0.5 μm as a main ingredient) containing cerium oxide abrasive grain having an average particle size smaller than that of the cerium oxide abrasive grain and a soft urethane pad as a polishing tool, and cerium oxide was cleaned off and removed.

In addition, the polishing machining of the upper and lower main surfaces was performed by a double-sided polishing apparatus using the polishing liquid (a polishing liquid composite having colloidal silica with an average particle size of a primary particle of about 20 to 30 nm as a main ingredient) containing colloidal silica and a soft urethane pad as a finishing polishing tool.

The doughnut-shaped circular glass plate after the finishing polishing was immersed in a solution which was adjusted to the same pH as the polishing liquid of the finishing polishing, a scrub cleaning using an alkaline detergent, an ultrasonic cleaning in the state of being immersed in an alkaline detergent solution, and an ultrasonic cleaning in the state of being immersed into pure water were sequentially performed, and the glass plate was dried by isopropyl alcohol steam.

After both main surfaces were polished and the cleaning and the drying were performed, an arithmetic average roughness (Ra) of the glass substrate main surface was measured by an atomic force microscope (produced by Digital Instruments Company, product name: Nano Scope D3000), and a minute wave (μWa) was measured by a scan type white interferometer (produced by Zygo Company, product name: Zygo New View 5032).

In the present embodiment, the arithmetic average roughness (Ra) of the main surface was equal to or less than 0.15 nm in the overall magnetic recording medium glass substrate, and the minute wave (μWa) was equal to or less than 0.15 nm in the overall magnetic recording medium glass substrate.

The number of pit defects in the chamfering portion of the magnetic recording medium glass substrate obtained in the present embodiment was evaluated according to the same sequence as the evaluation method of the number of pit defects after the inner periphery end surface polishing. A magnetic recording medium glass substrate having a number of pit defects in the chamfering portion of 5/mm² or less was determined as a good product.

Hereinafter, embodiments (a first example and a second example) in which the characteristics of the abrasion brush and the inner periphery end surface polishing condition were changed and comparison examples (a third example to an eighth example) will be described.

### First Example

Evaluation conditions of an inner periphery end surface abrasion brush, the characteristics of the used abrasion brush A and the inner periphery end surface polishing condition are indicated in Table 1.

As the inner periphery end surface abrasion brush, a abrasion brush (a abrasion brush A), in which a brush outer diameter is 22.5 mm (1.13 times the diameter of the circular hole formed in the center portion of the glass substrate), a diameter of the rotation shaft is 10 mm (50% of the diameter of the circular hole formed in the center portion of the glass substrate), a width of the bristle implanting portion of the brush bristles is 1.5 mm (1.7 times the stack width 0.87 mm that is the sum of the stacked glass substrate thickness 0.67 mm and the resin spacer thickness 0.2 mm), a width of the non-bristle implanting portion is 5 mm, a bristle diameter of the brush is 0.15 mm, and the implanted bristles of the brush bristles on the rotation shaft are 312 mm, was used to polish the inner periphery side surface portion and the inner periphery chamfering portion.

The glass substrate stacked body which was the polishing object was formed by alternately stacking the glass substrate (thickness 0.67 mm) and the resin spacer (thickness 0.2 mm) and the whole length T of the glass substrate stacked body in which 200 sheets of glass substrates were stacked was 174 mm.

The abrasion brush inserted into the circular hole of the center portion of the glass substrate stacked body was moved from the center of the circular hole in one direction, and in the state of pressing the brush bristles with respect to the inner periphery side surface of the glass substrate by 0.4 mm, the inner periphery end surface polishing was performed. The swinging velocity of the abrasion brush was 100 mm/min, and the swinging length was 40 mm (23% of the whole length T of the glass substrate stacked body).

Two sheets of abrasion brushes A were used, two lots of inner periphery end surface polishing were carried out with respect to each of the abrasion brushes A, and the abrasion brushes A were evaluated.

An average value (an inner periphery side surface polishing amount average value) of the polishing amount of the inner periphery end surface polishing that is a polishing characteristic evaluation result, a variation (an inner periphery side surface polishing amount standard deviation) of the polishing amount when the inner periphery side surface polishing amount average value within one lot is standardized as 12.5 μm, an average value of the polishing velocity, and a pit defect number evaluation result (a percentage of good product) of the inner chamfering portion are indicated in Table 2.

A variation of the polishing amount between the abrasion brushes, between the lots, and within the lot was small, and it was possible to perform a uniform inner periphery end surface polishing in a stable state. Furthermore, the pit defect did not exist in the inner periphery chamfering portion, and it was possible to completely remove the machining damage layer (scratches etc.) of the inner periphery chamfering portion all over the glass substrate stacked body.

### Third Example

As described in Table 1, the inner periphery end surface polishing was performed in the same manner as the first example except that the swinging length of the abrasion brush was 20 mm (11.5% of the whole length of the stacked glass substrates).

The polishing characteristic evaluation results are shown in Table 2. The pit defects did not exist in the inner periphery chamfering portion of the glass substrate, and it was possible to completely remove the machining damage layer (scratches etc.) of the inner periphery chamfering portion all over the glass substrate stacked body. However, since the swinging amount of the abrasion brush was shortened, between the abrasion brushes, between the lots, and within the lot, the variation (the standard deviation) of the inner periphery side surface polishing amount slightly increased.

### Fourth Example

As described in Table 1, except that the brush outer diameter of the abrasion brush was 19.5 mm (0.98 times the diameter of the circular hole formed in the center portion of the glass substrate), a diameter of the rotation shaft was 8 mm (40% of the diameter of the circular hole formed in the center portion of the glass substrate), the abrasion brush pressing amount of the inner periphery end surface polishing condition was 1.5 mm, and the brush swinging velocity was changed to 1500 mm/min, the inner periphery end surface polishing was performed in the same manner as the first example.

The polishing characteristic evaluation results are shown in Table 2. A large number of pit defects were observed in the inner periphery chamfering portion of the glass substrate situated at the center portion of the glass substrate stacked body (among 20 sheets of evaluated substrates, pit defects existed in 11 sheets of the glass substrates), and it was impossible to sufficiently remove the machining damage layer (the scratches etc.) of the inner periphery chamfering portion by the inner periphery end surface polishing.

### Fifth Example

As described in Table 1, except that the width of the bristle implanting portion was 2.0 mm (2.3 times the stack width 0.87 mm that is the sum of the stacked glass substrate thickness and the resin spacer thickness) and the channel height was 3 mm, the inner periphery end surface polishing was performed in the same manner as the first example.

The polishing characteristic evaluation results are shown in Table 2. Between the lots, and within the lot (the overall glass substrates of the glass substrate stacked body), the variation of the polishing amount was large, and upon widening the width of the bristle implanting portion, it was confirmed that the inner periphery end surface polishing could not be uniformly performed in a stable state. Furthermore, in the whole regions (the upper portion, the center portion, and the lower portion) of the glass substrate stacked body, a large number of pit defects were observed, and it was impossible to completely remove the machining damage layer (the scratches etc.) of the inner periphery chamfering portion by the inner periphery end surface polishing.

### Second Example, Sixth Example, and Seventh Example

As described in Table 1, except for using an abrasion brush A, an abrasion brush D, and an abrasion brush E in which the widths of the non-bristle implanting portion of the abrasion brush were different from each other, the inner periphery end surface polishing was performed in the same manner as the first example.

The polishing characteristic evaluation results are shown in Table 2.

Upon using the abrasion brush D (sixth example) in which the width of the non-bristle implanting portion was 5 mm, the polishing velocity accelerated, but the variation of the polishing velocity between the lots increased, whereby it was impossible to uniformly perform the inner periphery end surface polishing in a stable state. Upon using the abrasion brush E (seventh example) in which the width of the non-bristle implanting portion was 10 mm, the polishing velocity decreased and the productivity deteriorated. Furthermore, the life of the brush bristles of the abrasion brush was also shortened. For that reason, the variation of the polishing velocity between the lots increased, which made it impossible to uniformly perform the inner periphery end surface polishing in a stable state. Upon using the abrasion brush A (second example) in which the width of the non-bristle implanting portion was 6.5 mm, the variation of the polishing velocity decreased, and it was possible to perform the polishing in a stable state.

Pit defects were not observed in the chamfering portion of the glass substrate in which the end surface polishing was performed using the abrasion brush A, the abrasion brush D, and the abrasion brush E. From this, it was confirmed that the abrasion brush having the properties of the abrasion brush D and the abrasion brush E could remove the machining damage layer (the scratches etc.) of the inner periphery chamfering portion by the inner periphery end surface polishing all over the region of the glass substrate stacked body.

### Eighth Example

As described in Table 1, except for changing the diameter of the rotation shaft to 8 mm (40% of the diameter of the circular hole formed in the center portion of the glass substrate), the inner periphery end surface polishing was performed in the same manner as the first example. The polishing characteristic evaluation results are shown in Table 2. Pit defects did not exist in the inner periphery chamfering portion of the glass substrate after the inner periphery end surface polishing, and it was possible to completely remove the machining damage layer (scratches etc.) of the inner periphery chamfering portion all over the glass substrate stacked body. However, it was confirmed that the variation of the polishing amount increases between the lots and within the lot, which makes it impossible to uniformly perform the inner periphery end surface polishing in a stable state.

TABLE 1

| | example | example | example | example | example | example | example | example |
|---|---|---|---|---|---|---|---|---|
| | 1 | 2 | 3 | 4 | 5 | 6 | 7 | 8 |
| evaluation condition of the inner | | | | | | | | |
| periphery end surface abrasion brush | | | | | | | | |
| brush type | A | A | A | B | C | D | E | F |
| the number of evaluated brush (number) | 2 | 1 | 2 | 2 | 1 | 1 | 1 | 1 |
| polishing evaluation number [lot]/[number] | 2 | 5 | 2 | 1 | 2 | 5 | 5 | 2 |
| glass substrate stack number [number] | 200 | 200 | 200 | 200 | 200 | 200 | 200 | 200 |
| polishing amount, pit defect evaluation | 20 | 10 | 20 | 20 | 20 | 10 | 10 | 20 |
| substrate number [number]/[lot] | | | | | | | | |
| characteristics of abrasion brush | | | | | | | | |
| outer diameter [mm] | 22.5 | 22.5 | 22.5 | 19.5 | 22.5 | 22.5 | 22.5 | 22.5 |
| (outer diameter)/(diameter of the circular | 1.13 | 1.13 | 1.13 | 0.98 | 1.13 | 1.13 | 1.13 | 1.13 |
| hole formed in the center portion of the | | | | | | | | |
| glass substrate) | | | | | | | | |
| diameter of the rotation shaft [mm] | 10 | 10 | 10 | 8 | 10 | 10 | 10 | 8 |
| (diameter of the rotation shaft)/(diameter of | 50 | 50 | 50 | 40 | 50 | 50 | 50 | 40 |
| the circular hole formed in the center | | | | | | | | |
| portion of the glass substrate) × 100 [%] | | | | | | | | |
| width of the bristle implanting portion [mm] | 1.5 | 1.5 | 1.5 | 1.5 | 2 | 1.5 | 1.5 | 1.5 |
| (width of the bristle implanting portion)/ | 1.7 | 1.7 | 1.7 | 1.7 | 2.3 | 1.7 | 1.7 | 1.7 |
| (stack width) | | | | | | | | |
| width of the non-bristle implanting portion [mm] | 5 | 5 | 5 | 5 | 5 | 3.5 | 8.5 | 5 |
| brush bristle diameter [mm] | 0.15 | 0.15 | 0.15 | 0.15 | 0.15 | 0.15 | 0.15 | 0.15 |
| implanting length of brush bristles [mm] | 312 | 312 | 312 | 312 | 312 | 312 | 312 | 312 |
| condition of the inner periphery | | | | | | | | |
| end surface polishing | | | | | | | | |
| abrasion brush pressing amount [mm] | 0.4 | 0.4 | 0.4 | 1.5 | 0.4 | 0.4 | 0.4 | 0.4 |
| abrasion brush swinging velocity [mm/min] | 100 | 100 | 100 | 1500 | 100 | 100 | 100 | 100 |
| abrasion brush swinging length [mm] | 40 | 40 | 20 | 40 | 40 | 40 | 40 | 40 |
| (abrasion brush swinging length)/(the | 23.0 | 23.0 | 11.5 | 23.0 | 23.0 | 23.0 | 23.0 | 23.0 |
| whole length of the glass substrate | | | | | | | | |
| stacked body) × 100 [%] | | | | | | | | |

TABLE 2

| | example 1 | | | | example 3 | | | |
|---|---|---|---|---|---|---|---|---|
| brush type No. | A-1 | | A-2 | | A-3 | | A-4 | |
| lot No. | 1 | 2 | 3 | 4 | 1 | 2 | 3 | 4 |
| inner periphery side surface | 12.1 | 12.0 | 12.1 | 12.2 | 13.7 | 11.7 | 13.0 | 12.1 |
| polishing amount average | | | | | | | | |
| value [μm] | | | | | | | | |
| inner periphery side surface | 1.21 | 0.95 | 0.97 | 1.00 | 1.63 | 1.53 | 1.42 | 1.51 |
| polishing amount standard | | | | | | | | |
| deviation [μm] (standard- | | | | | | | | |
| ization by the inner | | | | | | | | |
| periphery side surface | | | | | | | | |
| polishing amount 12.5 μm) | | | | | | | | |
| polishing velocity average | 2.30 | 2.21 | 2.32 | 2.26 | 2.34 | 2.20 | 2.31 | 2.23 |
| value [μm/min] | | | | | | | | |
| pit defect number evaluation | 100 | 100 | 100 | 100 | 100 | 100 | 100 | 100 |
| result of the inner periphery | | | | | | | | |
| chamfering portion | | | | | | | | |
| Percentage of good product [%] | | | | | | | | |

| | | | | | exam- | exam- | exam- | | |
|---|---|---|---|---|---|---|---|---|---|
| | example 4 | | example 5 | | ple 2 | ple 6 | ple 7 | example 8 | |
| brush type No. | B-1 | B-2 | C-1 | | A-3 | D-1 | E-1 | F-1 | |
| lot No. | 1 | 2 | 1 | 2 | 1 | 1 | 1 | 1 | 2 |
| inner periphery side surface | 13.4 | 12.7 | 13.4 | 12.7 | | | | 11.5 | 11.6 |
| polishing amount average | | | | | | | | | |
| value [μm] | | | | | | | | | |
| inner periphery side surface | 0.99 | 0.87 | 1.55 | 1.87 | 0.08 | 0.09 | 0.12 | 1.52 | 3.09 |
| polishing amount standard | | | | | | | | | |
| deviation [μm] (standard- | | | | | | | | | |
| ization by the inner | | | | | | | | | |
| periphery side surface | | | | | | | | | |
| polishing amount 12.5 μm) | | | | | | | | | |
| polishing velocity average | 1.49 | 1.41 | 4.03 | 4.13 | 2.31 | 2.93 | 1.41 | 0.62 | 0.58 |
| value [μm/min] | | | | | | | | | |
| pit defect number evaluation | 45 | 45 | 0 | 0 | 100 | 100 | 100 | 100 | 100 |
| result of the inner periphery | | | | | | | | | |
| chamfering portion | | | | | | | | | |
| Percentage of good product [%] | | | | | | | | | |

### INDUSTRIAL APPLICABILITY

The present embodiment may provide a glass substrate without pit defects in a chamfering portion of the glass substrate. Furthermore, it is possible to provide an end surface polishing method that reliably polishes a side surface portion and a chamfering portion of the glass substrate with high productivity, and a method of manufacturing the glass substrate.

What is claimed is:

1. A method of manufacturing a magnetic recording medium glass substrate, the method comprising:
preparing a plurality of glass substrates, each of which has a disk shape including a circular hole in a center portion of the glass substrate, an inner periphery side surface, an outer periphery side surface, and upper and lower main surfaces;
polishing the main surfaces of each of the glass substrates;
performing chamfering machining of the inner periphery side surface of each of the glass substrates to form an inner periphery chamfering portion; and
polishing the inner periphery side surface and the inner periphery chamfering portion of each of the glass substrates by:
stacking the plurality of glass substrates,
supplying a polishing liquid containing free abrasive grains to the inner periphery side surfaces and the inner periphery chamfering portions of the glass substrates, and
bringing an abrasion brush, which has a rotation shaft and brush bristles implanted in the rotation shaft, into contact with the inner periphery side surfaces and the inner periphery chamfering portions while rotating the abrasion brush,
wherein the abrasion brush has bristle implanting portions where the brush bristles are implanted and non-bristle implanting portions where the brush bristles are not implanted, and
wherein the bristle implanting portions are formed to have a pitch width so that the non-bristle implanting portions are formed between the bristle implanting portions, and
wherein a width of each of the bristle implanting portions is 1.1 to 2.2 times a stack width of the stacked glass substrates.

2. The method of manufacturing the magnetic recording medium glass substrate according to claim 1,
wherein the stack width is a thickness of each of the glass substrates when the glass substrates are stacked without using a spacer.

3. The method of manufacturing the magnetic recording medium glass substrate according to claim 1,
wherein the stack width is a sum of the thickness of the glass substrates and a spacer when the glass substrates are stacked using spacers.

4. The method of manufacturing the magnetic recording medium glass substrate according to claim 1,
wherein a width of the non-bristle implanting portion is 3 to 9 mm.

5. The method of manufacturing the magnetic recording medium glass substrate according to claim 1,
wherein an outer diameter of the abrasion brush is 1.03 to 1.25 times a diameter of the circular hole formed in the center portion of the glass substrate.

6. The method of manufacturing the magnetic recording medium glass substrate according to claim 1,
wherein a diameter of the rotation shaft is 41% to 65% of a diameter of the circular hole formed in the center portion of the glass substrate.

7. The method of manufacturing the magnetic recording medium glass substrate according to claim 1,
wherein the abrasion brush polishes the inner periphery side surface and the inner periphery chamfering portion by swinging in a stacked direction of the stacked glass substrates, and a swinging length of the abrasion brush is equal to or larger than 15% of a length of the stacked glass substrates.

8. A magnetic recording medium glass substrate manufactured by the method of manufacturing the magnetic recording medium glass substrate according to claim 1,
wherein, in at least one of the inner periphery chamfering portion and the outer periphery chamfering portion of the magnetic recording medium glass substrate, the number of pit defects, which have a diameter of 10 μm or more, is equal to or less than 5/mm².

9. A magnetic recording medium glass substrate comprising a disk shape including a circular hole in a center portion of the glass substrate, an inner periphery side surface, an outer periphery side surface, and upper and lower main surfaces, wherein a chamfering portion is formed in a place intersecting at least one of the upper and lower main surfaces and at least one of the inner periphery side surface and the outer periphery side surface, and
wherein in the chamfering portion of the magnetic recording medium glass substrate, the number of pit defects, which have a diameter of 10 μm or more, is equal to or less than 5/mm².
